(19) United States
(12) Patent Application Publication
(10) Pub. No.: US 2012/0279306 A1
(43) Pub. Date: Nov. 8, 2012

(54) Mechanical Nanoresonator for Extremely Broadband Resonance

(75) Inventors: Min-Feng Yu, Champaign, IL (US); Han Na Cho, Champaign, IL (US); D. Michael McFarland, Urbana, IL (US); Lawrence A. Bergman, Champaign, IL (US); Alexander Vakakis, Champaign, IL (US)

(73) Assignee: The Board of Trustees of the University of Illinois, Urbana, IL (US)

(21) Appl. No.: 13/501,829

(22) PCT Filed: Oct. 15, 2010
(86) PCT No.: PCT/US10/52810

§ 371 Date: Jul. 19, 2012

Related U.S. Application Data
(60) Provisional application No. 61/251,770, filed on Oct. 15, 2009.
(60) Provisional application No. 61/296,191, filed on Jan. 19, 2010.

(51) Int. Cl. G01N 29/22; H01P 7/00

(52) U.S. Cl. 73/579; 333/219

(57) ABSTRACT

In an embodiment, provided are nanoresonators, nanoresonator components and related methods using the nanoresonators to measure parameters of interest. In an aspect, provided is a nanoresonator component comprising an elongated nanostructure having a central portion, a first end, and a second end and an electrode having a protrusion ending in a tip that is positioned adjacent to the elongated nanostructure. The electrode is used to impart a highly-localized driving force in a perpendicular direction to the nanostructure to induce geometric non-linear deformation, thereby generating non-linear resonance having a broadband resonance range that spans a frequency range of at least one times the elongated nanostructure natural resonance frequency.

### CROSS-REFERENCE TO RELATED APPLICATIONS

This application claims benefit of U.S. Provisional Patent App. Nos. 61/251,770 filed Oct. 15, 2009 and 61/296,191 filed Jan. 19, 2010, each of which is specifically incorporated by reference herein to the extent not inconsistent with the present application.

### BACKGROUND OF THE INVENTION

Provided are nanoresonators that are nonlinear broadband resonators that are capable of sensing or transmitting one or more physical parameters. Currently, typical nanoresonators operate in the linear regime and are designed to operate at a single nontunable resonant frequency; i.e., they are narrowband devices. By contrast the devices provided herein operate in the strongly nonlinear regime and are broadband devices.

Effort by Jensen et al. (2006) relates to a tunable linear nanoresonator made of a multiwalled carbon nanotube suspended between a metal electrode and a piezo-controlled contact. By controlled telescoping it is possible to controllably slide an inner nanotube core from an outer casing, which in effect changes the flexibility of the nanoresonator and tunes the resonant frequency. That device, however, remains fundamentally linear, is not self-tuned, and its operation is still narrowband once its configuration is fixed. Other effort [e.g. (Jun et al., 2007)] is directed to examination of nonlinear stretching effects in nanoresonators; however, the range of resonance achieved is on the order of 0.1-1.0 MHz, which is orders of magnitude smaller than the range of an extremely broadband nanoresonator (e.g., 15-20 MHz).

Nanoresonators provided herein, in contrast, are designed to operate in the strongly nonlinear regime, which is achieved by incorporation of intentional geometric nonlinearity to achieve broadband nonlinear resonance. Conventional designs are linear, or at best treat nonlinear effects as mere perturbations of the linear and, in essence, regard them as detrimental to the design objectives. Designs provided herein are transformative in the area of nanoresonators and are the first application of intentional strong geometric nonlinearity in the nanoscale regime.

### SUMMARY OF THE INVENTION

Disclosed herein is the design, fabrication and test of a new class of strongly nonlinear nanoresonators with capacity for extremely broadband resonance. The design utilizes strong geometric nonlinearities that are induced in the nanoscale. Further provided are various processes and applications of these broadband resonators, including mass sensors of extreme sensitivity that are orders of magnitude higher than current state-of-the-art. In addition, the devices are capable of probing, characterization and further study of the internal dynamics of other nanodevices. The devices and processes provide an intentionally localized driving force with a resultant geometric nonlinear deformation to generate broadband resonance.

In an embodiment, provided is a nanoresonator component having an elongated nanostructure with a central portion that is positioned between first and second ends, and each of the ends is fixed in position. Adjacent to the elongated nanostructure central portion is an electrode having a protrusion ending in a tip, and the longitudinal axis of the protrusion is substantially transverse to the longitudinal axis of the elongated nanostructure. Accordingly, the electrode geometry and positioning relative to the elongated nanostructure provides the capability to generate an intentionally localized or confined driving force on the elongated nanostructure with geometric nonlinear deformation of the elongated nanostructure in response to the intentionally localized driving force. In this manner, upon resonance the elongated nanostructure generates non-linear resonance having a broadband resonance range that spans a frequency range of at least one times the elongated nanostructure natural resonance frequency.

In an aspect, the elongated nanostructure is a nanowire or a nanotube.

In an aspect, the invention is further described in terms of the tip geometry. In an embodiment the tip comprises a tapered geometry. In an aspect the tip tapers to a point that corresponds to the closest approach of the electrode to the elongated nanostructure. In an aspect, the taper is to a point that has a dimension in a direction parallel to the elongated nanostructure that is less than or equal to 100 nm. In an aspect, the tip point of the taper corresponds to a rounded end.

In an embodiment, the invention is further described in terms of various dimensions and geometry of the elongated nanostructure. In an aspect, the elongated nanostructure has a longitudinal length and said tip has a characteristic width, wherein said characteristic width is less than or equal to 10% of the elongated nanostructure longitudinal length.

In another aspect, the electrode is further described in terms of an electrode geometry. In an embodiment, the electrode geometry (including for an electrode portion that does not include the protrusion portion) is substantially rectangular or is rectangular, having a width in a direction in longitudinal alignment with the elongated nanostructure that is less than or equal to 10% the length of the elongated nanostructure.

In an embodiment, the tip is positioned a separation distance from the elongated nanostructure, wherein the separation distance is less than or equal to 20 μm.

In an aspect, the elongated nanostructure has an outer diameter that is less than or equal to 300 nm and a length that is less than or equal to 100 μm.

In another embodiment, the nanoresonator component further comprises a first end electrode connected to the elongated nanostructure first end and a second end electrode connected to the elongated nanostructure second end.

In an embodiment, the broadband resonance ranges from the natural resonance frequency of the elongated nanostructure to 1 GHz.

In an aspect, the central portion corresponds to a point that is equidistant from the first end and the second end.

In an embodiment, the electrode generates an electric field induced force on the elongated nanostructure central region, wherein the electric field induced force has a direction that is substantially perpendicular to the longitudinal axis of said elongated nanostructure.

In an aspect the elongated nanostructure is substantially tension-free at rest or has a tension smaller than that required to produce a corresponding strain of 0.002 in the elongated nanostructure at rest.

In an embodiment, the invention is a method of detecting a physical parameter with a nonlinear broadband nanoresonator, including a nonlinear broadband nanoresonator comprising any of the nanoresonator components provided herein. In an aspect, the method relates to providing any of the nanoresonator components described herein, supplying an oscillating electric potential to the electrode tip to generate an oscillating driving point force positioned at the elongated nanostructure central region, wherein the driving point force generates a nonlinear resonance from the elongated nanostructure, and measuring a resonance parameter, thereby detecting the physical parameter.

In an aspect, the supplied oscillating electric potential generates a periodic driving point force within the elongated nanostructure central region.

The methods provided herein are capable of detecting any one or more physical parameters, such as a physical parameter that is the mass of an analyte, energy transfer between the elongated nanostructure and a second nanoscale device operably connected to the nanoresonator, or a property of an environment surrounding the nanoresonator selected from the group consisting of pressure, viscosity, magnetic field, and electric field.

In an aspect, the resonance parameter is selected from the group consisting of drop frequency or shift in drop frequency, resonance bandwidth, phase of the resonance; amplitude, and slope of the resonant curve at one or more selected frequencies.

In another embodiment, the device or method relates to functionalizing at least a portion of the elongated nanostructure to facilitate specific binding between an analyte and the elongated nanostructure; wherein the measured resonance parameter indicates the presence or absence of the analyte.

In an aspect, the detection occurs under an environmental condition selected from the group consisting of vacuum pressure, atmospheric or ambient pressure, at room temperature, below room temperature, and above room temperature. Room temperature, in an aspect, refers to the bulk average temperature of the room in which the device resides, and therefore, can vary. In another aspect, room temperature is defined in terms of an explicit temperature range typically encountered, such as between about 16° C. and 24° C., or about 20° C.

In an embodiment, the physical parameter is mass, and the method provides a sensitivity that is at least 1 femtogram or at least 1 attogram at room temperature.

In an embodiment, the nanoresonator is driven at a sweeping resonant frequency, wherein the resonant frequency sweep ranges from a minimum that is less than or equal to 5 MHz to a maximum that is greater than or equal to 14 MHz.

In another embodiment, provided is a method for measuring mass. In an aspect, the method relates to providing a nonlinear nanoelectromechanical resonator including an oscillating element and an electronic circuit to drive the oscillating element, the nanomechanical resonator exhibiting an initial jump frequency under vacuum or ambient conditions, adsorbing mass onto the oscillating element, and determining the jump frequency of the nanomechanical resonator in the presence of the adsorbed mass, wherein the change from the initial value of the jump frequency indicates the magnitude of the mass added to the oscillating element. In an aspect, the nonlinear nanoelectromechanical resonator comprises any of the nanoresonator components disclosed herein.

Without wishing to be bound by any particular theory, there can be discussion herein of beliefs or understandings of underlying principles or mechanisms relating to embodiments of the invention. It is recognized that regardless of the ultimate correctness of any explanation or hypothesis, an embodiment of the invention can nonetheless be operative and useful.

### DESCRIPTION OF THE DRAWINGS

FIG. 1A: Schematic diagram showing a simple doubly clamped mechanical beam (and its equivalent spring model) having an intrinsic geometric nonlinearity. The geometric nonlinearity is introduced by simply employing a linearly elastic beam with negligible bending stiffness. A point force F applied to the center mass produces a displacement x satisfying the relation: kx[1−L(L²+x²)^{-1/2]≈(k/}2L²)x³+O(x⁵), where L is the half-length of the beam and k is its longitudinal spring constant. Due to the total absence of a linear term (a kx term), there is no preferential resonant frequency for such a system, and the resonant response is thus broadband. 1B is a schematic illustration of one embodiment of a nanoresonator of the present invention.

FIG. 2: Linear versus nonlinear resonant responses. The nonlinear resonance covers a full frequency spectrum while the linear resonance peaks only at a specific frequency. The dots (•) mark the unstable resonance branch (inaccessible resonances) in the nonlinear resonance response.

FIG. 3: SEM images showing a nonlinear nanoresonator at stationary (top) and on resonance (bottom). In this example, the nanoresonator is driven by an oscillating electric field applied between a protruding electrode having a tapered tip and the suspended nanotube. The driving force applied onto the nanotube central region is thus locally distributed near the center segment of the nanotube.

FIG. 4: The acquired resonance response curve during the forward (labeled “black”) and backward (labeled “red”) frequency sweep. The nanolinear nanoresonator is seen to resonate in a broad frequency band starting from ˜4 MHz up to ˜20 MHz.

FIG. 5: Experiments showing the change of the switching frequency and the bandwidth of the nonlinear nanoresonator with the added mass. In the process, small Pt beads of different size are deposited in situ on the nanotube, and the corresponding response curves are acquired. Including the response curve in FIG. 4 acquired from the same nanoresonator without the added mass, the switching frequencies are ˜20, ˜14, ˜10 and ˜6 MHz according to the acquired response curves. Based on the sizes of the deposited Pt beads, the added masses are estimated to be approximately 25, 170, and 380 fg (femto-gram, 10⁻¹⁵ g) in each deposition, which translates to a mass sensitivity in the order of 10 fg/MHz or 10 atto-gram/kHz.

FIG. 6: Tunability of the resonance bandwidth of a nonlinear nanoresonator. The plot shows the dependence of the drop frequency/natural frequency ratio on the applied drive force and the quality factor of the mechanical resonator. The plot in the inset shows the frequency response of a nonlinear resonator calculated based on the parameters listed for a carbon nanotube B1 in the inset of FIG. 7.

FIG. 7: Sensing performance of a nonlinear nanoresonator to mass and to energy dissipation due to damping. (A) Mass responsivities of four different doubly-clamped beams as a function of the drop frequency/natural frequency ratio. (B) Shift in the drop frequency for a 1% change of damping coefficient as a function of the drop frequency/natural frequency ratio. The inset table lists the parameters for the carbon nanotubes used in the calculation.

FIG. 8: Fabricated nonlinear carbon nanotube nanoresonator and its resonance response. (A) SEM images in top view and tilted view of a representative nanoresonator employing a CNT suspended between and fixed at both ends on the fabricated platinum electrode posts. The acquired response spectra of a CNT (2L=˜6.2 μm, D=˜33 nm) nonlinear nanoresonator driven with AC voltage signals of 10 V (B) and 5 V (C) in amplitude.

FIG. 9: Mass sensing with a nonlinear carbon nanotube nanoresonator. (A) SEM image showing the Pt deposit at the middle of a suspended CNT (2L=˜6.0 μm, D=˜26 nm). The acquired response spectrum of this CNT nonlinear nanoresonator before (∘) and after (•) depositing a center mass with the electron beam-induced deposition.

FIG. 10: Schematic diagram of a device used in the experiment.

FIG. 11: Transverse force distribution per unit length along the carbon nanotube.

### DETAILED DESCRIPTION OF THE INVENTION

As used herein, “fixed” refers to regions of the elongated nanostructure that are not free to move in response to an applied force. For example, ends of elongated nanostructure that are connected to end electrodes are not free to move in response to a driving force applied by a driving electrode to the central region of the elongated nanostructure.

“Elongated nanostructure” refers to a structure having a longitudinal length and a dimension perpendicular to the longitudinal length that is less than or equal to 1 μm, less than or equal to 100 nm, or less than or equal to 50 nm. In an aspect, the perpendicular dimension relates to an outer diameter for a cylindrical shaped nanostructure such as a tube or a wire. Alternatively, perpendicular dimension relates to a width or a height for a nanostructure that is not cylindrically-shaped. In an aspect, the nanostructure has a length that is not on a nanometer-dimension scale, such as greater than or equal to 1 μm, greater than or equal to 5 μm, or greater than or equal to 1 μm and less than or equal to 10 μm.

“Substantially transverse” refers to a direction that is approximately perpendicular to a reference direction. In an aspect, substantially transverse is within 10°, 5° or 1° of perpendicular. Similarly, “substantially rectangular” refers to a geometric shape having an angle that is within 10°, 5° or 1° of 90°.

“Substantially tension free” refers to an elongated nanostructure that is not under tension when connected to end electrodes and reflects the fact that there is generally some residual tension when fixing ends of an elongated nanostructure. In an aspect, substantial tension to the elongated nanostructure is avoided, such as by processing the elongated nanostructure to have a strain that is less than or equal to 0.002.

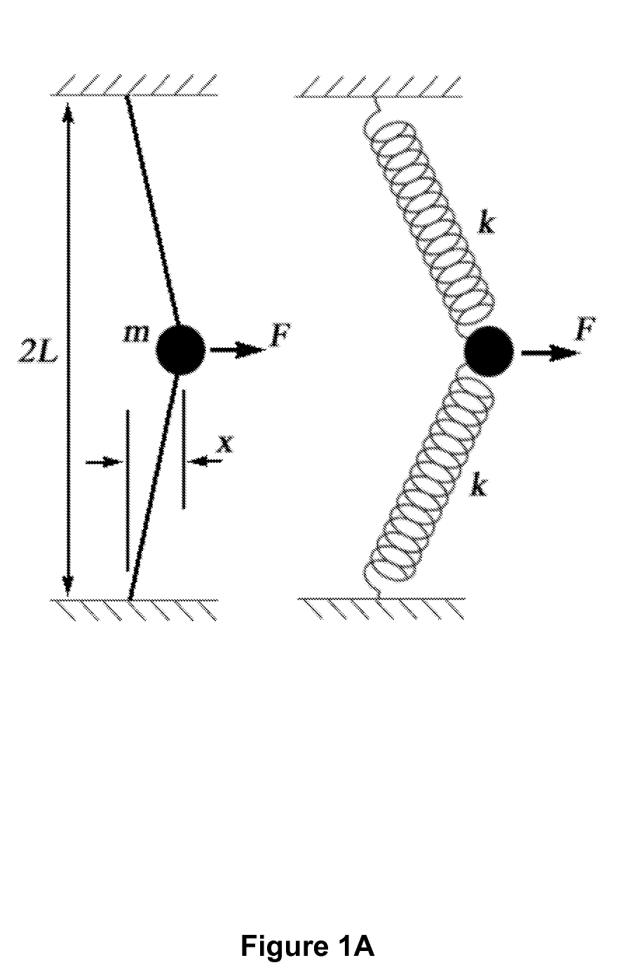

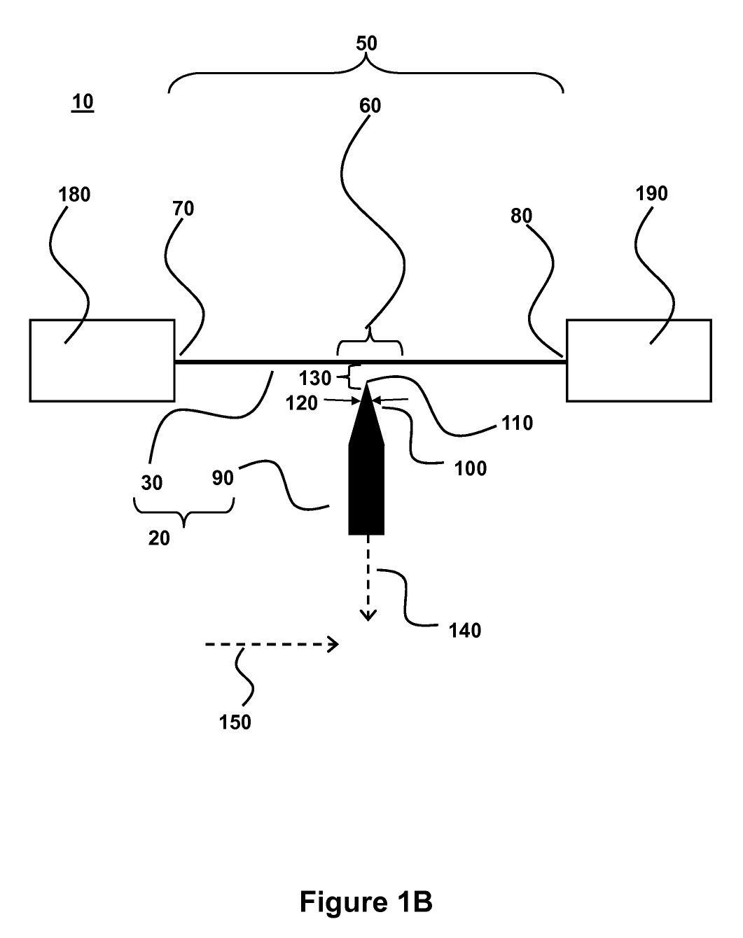

Provided herein is a new class of strongly nonlinear mechanical nanoresonators with capacity for extremely broadband resonance. In an embodiment, the nanoresonator comprises a suspended elongated nanostructure such as a nanowire (or a suspended nanotube) with fixed ends and driven transversely by a periodic excitation force exerted locally onto the center segment of the suspended nanowire (or nanotube) (FIG. 1).

FIG. 1B schematically illustrates one embodiment of the device. Illustrated is a nanoresonator 10 having a nanoresonator component 20 formed from an elongated nanostructure 30 and electrode 90. The elongated nanostructure 30 has a longitudinal length 50 (e.g., length in direction 150), with a central portion 60 that is between first end 70 and second end 80. Ends 70 and 80 are fixed to first end electrode 180 and second end electrode 190, respectively. Electrode 90 is used to impart a driving force on the elongated nanostructure 30 central portion 60. Electrode 90 has a protrusion 100 and a tip 110 that is positioned adjacent to the elongated nanostructure 30 central portion 60, such as separated by a separation distance 130. In an aspect “adjacent” refers to a separation distance that is sufficiently small to provide adequate force to generate a non-linear response in the nanoresonator. In an aspect, adjacent refers to a separation distance that is less than or equal to 20 μm. In an aspect, the tip 110 corresponds to a point at the end of a taper of protrusion 100. Electrode 90, and specifically protrusion portion 100 can be described as having a characteristic width 120. “Characteristic width” refers to a dimension of the electrode in a direction that is parallel to the longitudinal axis 150 of the elongated nanostructure 30, and may be the width at a select position (e.g., at a select position along a direction of the longitudinal axis 140 of the electrode 90) of the electrode 90, an average width along the protrusion 100, or a minimum width that occurs at the tip 110. In this example, the longitudinal axis 140 of the protrusion 100 is perpendicular to the longitudinal axis of the elongated nanostructure 150, as indicated by the direction of dashed arrows in FIG. 1B.

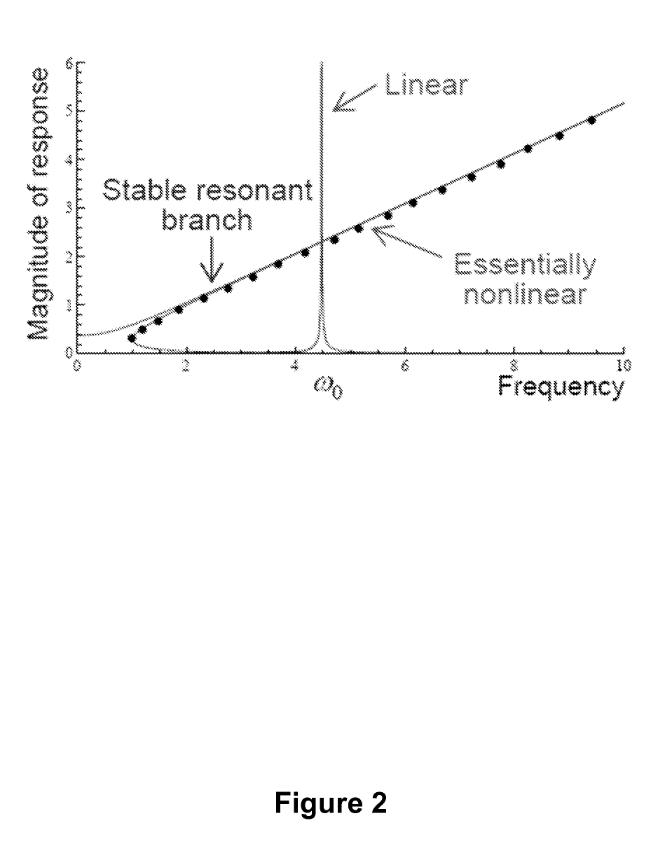

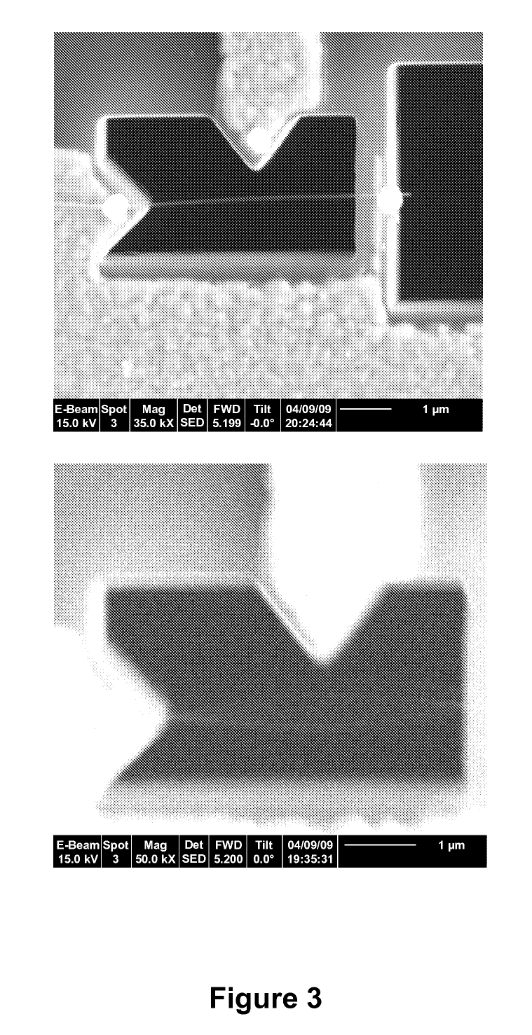

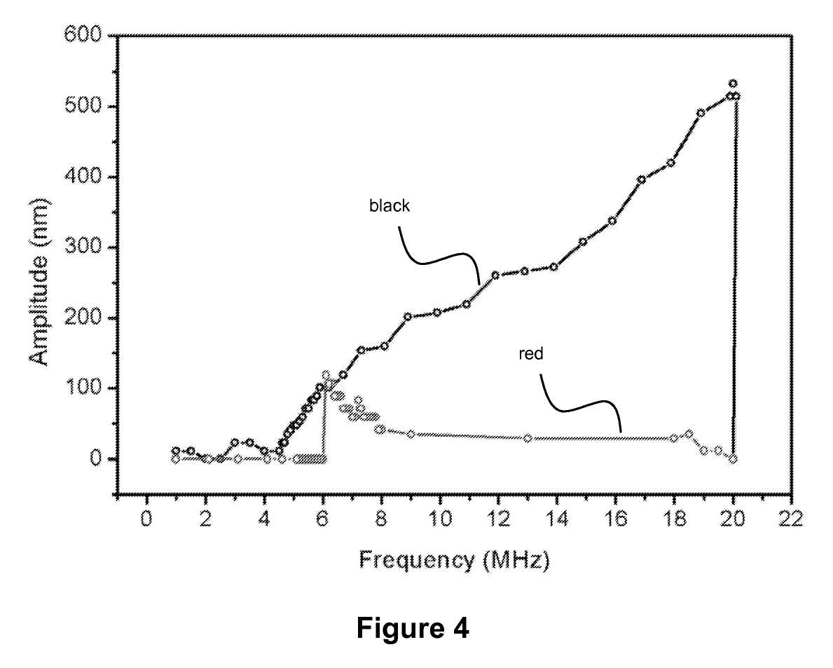

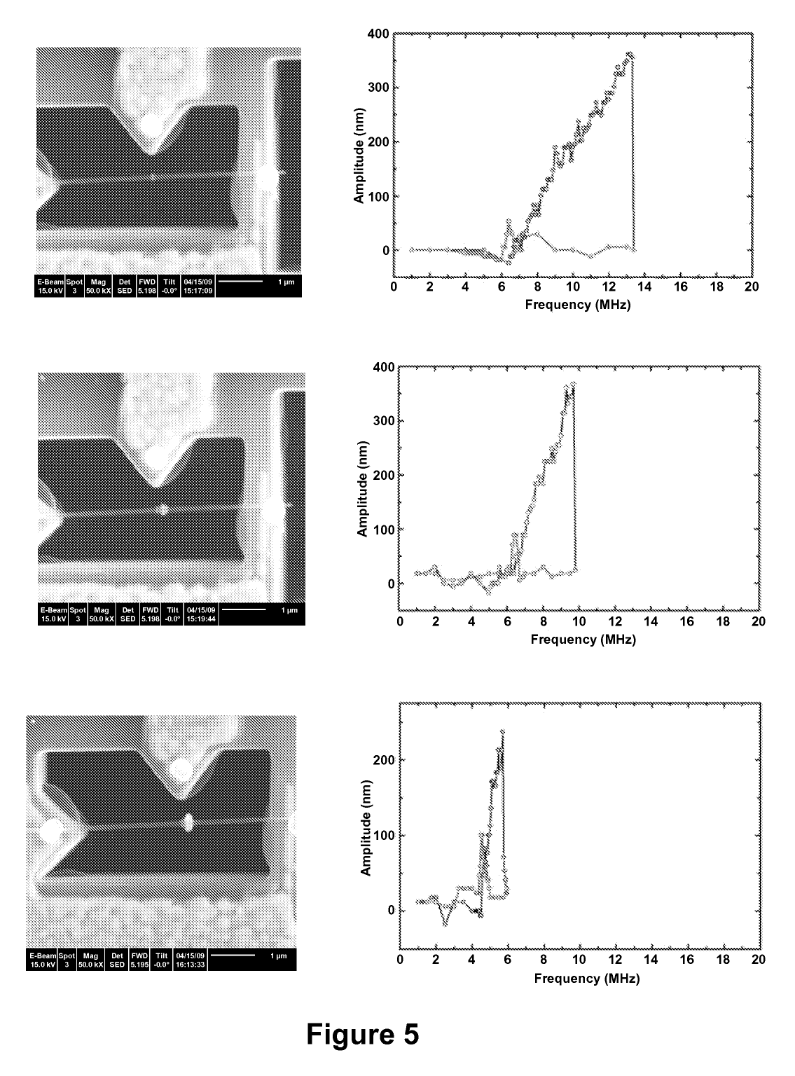

This unique excitation scheme with a highly-localized force dictates that the resistance to bending of the suspended nanowire (or nanotube) is governed by a geometrically nonlinear force-displacement dependence of cubic order, intrinsically different from typical linear mechanical resonators operated under a linear force-displacement dependence. A linear force-displacement dependence determines a singular spring constant, which in turn determines a singular resonant frequency. A cubic force-displacement dependence mathematically encompasses an infinite number of spring constants, and thus allows the system to resonate over a broad spectrum of frequencies (FIG. 2). In preliminary experiments, we fabricate and test such a nanoresonator that exhibits broadband resonance spanning 15 MHz, or more (FIGS. 3-4). This represents transformative technology, as the resonant range achieved by our nanoresonator design is several orders of magnitude broader than those achieved by current nanoresonators. Moreover, the present broadband nanoresonator is highly sensitive to added mass, so it can be used as a high-sensitivity mass sensor, with sensitivity several orders of magnitude better than those achieved by current nanosensors (FIG. 5). In addition, devices provided herein can absorb vibration energy from other nanodevices over a broad range of frequencies, so it can be used as an efficient strongly nonlinear vibration absorber in the nanoscale. In all of the aforementioned, the nanoresonator design represents transformative technology.

Applications for the strongly nonlinear broadband nanoresonators provided herein include mass sensors of high sensitivity, orders of magnitude higher than current linear and weakly nonlinear sensor designs. In addition, the strongly nonlinear nanoresonators provided herein can be used as a passive broadband absorber for achieving broadband targeted energy transfer from other nanoscale devices.

High sensitivity mass sensing of the disclosed devices provide the capability for production of biological and chemical nanosensors with sensitivities orders of magnitude greater than current sensing devices. Moreover, it provides the first application of the use of intentional strong geometric nonlinearity for the nanoresonators with capacity for extreme broadband resonance.

### Example

### Tunable and Broadband Nonlinear Nanomechanical Resonator

A nanomechanical resonator intentionally operated in a highly nonlinear regime is modeled and developed. This nanoresonator is intrinsically nonlinear and capable of extremely broadband resonance, with tunable resonance bandwidth up to several times its natural frequency. Its resonance bandwidth and drop-frequency (the upper jump-down frequency) are found to be highly sensitive to added mass and to energy dissipation due to damping. A nonlinear mechanical nanoresonator integrating a doubly-clamped carbon nanotube as the flexible (oscillating) element is developed and shown to achieve a mass sensitivity over two orders of magnitude higher than a linear one at room temperature, besides realizing a broadband resonance spanning over three times its natural frequency.

Nanomechanical resonators have been used to detect extremely small physical quantities (1-11) and to understand quantum effects (12-13) and interactions (14). Noticeably, their recent development has allowed the sensing of mass down to the zepto-gram (zg) level (7), and the sensing of a single molecule (9, 11). Most current nanoresonator designs use mechanical cantilevers or doubly-clamped beams in resonance. A general feature in such devices is that they operate predominantly in the linear regime and achieve high mass sensitivity through the realization of high quality-factor resonance at high frequencies. However, the reduced size down to nanoscale of the mechanical beams inadvertently introduces significant nonlinear effects (such as geometric or kinematic nonlinearities) at large resonance oscillation amplitudes and, accordingly, reduces their dynamic range of linear resonance operation (15). As a result, the importance of nonlinearity in nanomechanical resonance systems is gaining more attention. For example, electrostatic interactions (16) and coupled nanomechanical resonators (17) are proposed for tuning the nonlinearity in nanoscale resonance systems; noise-enabled transitions in a nonlinear resonator are analyzed to improve the precision in measuring the linear resonance frequency (18); and a homodyne measurement scheme for a nonlinear resonator is proposed for increasing the mass sensitivity and reducing the response time (19). In addition, the basins of attraction of stable attractors in the dynamics of a nanowire-based mechanical resonator is studied (20), and the nonlinear behaviors of an embedded (21) and a curved (22) carbon nanotube are theoretically investigated.

Such studies, however, still treat the increasingly prominent nonlinear behavior in a nanomechanical resonator as a design problem to be remedied or as a derivative issue to be considered only to improve the linear mechanical resonance system (23), instead of directly exploiting this nonlinear behavior for developing conceptually new devices and applications. In this example, we intentionally design and drive an intrinsically nonlinear nanomechanical resonator into a highly nonlinear regime, and apply both theoretical modeling and experimental validation to demonstrate its tunability and its capacity for broadband resonance. More importantly, we show that this intentional intrinsically nonlinear design is capable of providing extremely high sensitivity to mass and to energy dissipation due to damping.

Ideally, a fixed-fixed mechanical beam resonator employing a linearly elastic wire with negligible bending stiffness and no initial axial pretension exhibits strong geometric nonlinearity and becomes an intrinsically (purely) nonlinear resonator when driven transversely by a periodic excitation force applied locally at the middle of the wire. That is, its dynamic response is nonlinearizable, as it possesses a zero linearized natural frequency. Indeed, in such a resonator, the force-displacement dependence is described by the relation F=kx[1−L(L²+x²)^{-1/2}]≈(k/2L²)x³+O(x⁵) (24), where F is a transverse point force applied to the middle of the wire, x is the transverse displacement at the middle of the wire, and L and k are the half-length and the effective axial spring constant of the wire, respectively. Due to the total absence of a linear force-displacement dependence term (i.e., a term of the form kx) and the realization of a geometrically nonlinear force-displacement dependence of pure cubic order, this resonator has no preferential resonance frequency, and its resonant response is broadband (24), conceptually different from typical linear mechanical resonators. Moreover, the apparent resonance frequency is completely tunable by the instantaneous energy of the beam. If the bending effects are non-negligible, or if an initial pretension exists in the wire, a nonzero linear term in the previous force-displacement relation is included, giving rise to a preferential resonance frequency. However, as long as this preferential frequency is sufficiently small compared to the frequency range of the nonlinear resonance dynamics, the previous conclusions still apply (24).

Thus, we proceed to analyze a doubly-clamped Euler-Bernoulli beam having a foreign mass (m_{c})) attached at its middle and excited transversely by an alternating center-concentrated force. Considering the geometric nonlinearity induced by axial tension during oscillation, the vibration of the beam is described by:

[ρA+m_{c}δ(x−L)]wₜₜ+(mω₀/Q)wₜ+EIwₓₓₓₓ−(EA/4L)wₓₓ∫₀^{2L}wₓ²dx=F cos ωtδ(x−L) (1)

where w(x,t) is the transverse displacement of the beam with x and t denoting the spatial and temporal independent variables, E and p are Young's modulus and mass density, A and L are the cross-sectional area and half-length of the beam, l is the area moment of inertia of the beam, Q is the quality factor of the resonator in the linear dynamic regime, F is the excitation force applied at the middle of the beam, ω(=2πf) is the driving frequency, and wₒ (=2πfₒ) is the linearized natural resonance frequency of the beam. It is assumed that no initial axial tension exists when the beam is at rest, and short hand notation for partial differentiation is used.

The transverse displacement of the beam can be approximately expressed as

$$w ( x , t ) = {\sum }_{i = 1}^{N} {W}_{i} ( x ) {φ}_{i} ( t ) ,$$

where Wᵢ(x) is the i-th linearized mode shape of the beam, φ₁(t) the corresponding i-th modal amplitude, and N is the number of beam modes considered in the approximation. The leading model amplitude, φ₁(t), is then approximately governed by a Duffing equation obtained by discretizing Eq. 1 through a standard one-mode Galerkin approach (25):

$$( 1 + M ) {\ddot{φ}}_{1} + \frac{{ω}_{0}}{Q} {\dot{φ}}_{1} + {ω}_{0}^{2} {φ}_{1} + α {φ}_{1}^{3} = q cos ( ω t ) . \qquad ( 2 )$$

Here, M=[m_{c}/(2ρAL)]W₁²(L)=(m_{c}/m₀)W₁²(L) is the ratio of the foreign mass to the overall mass of the beam multiplied by a factor due to the center-concentrated geometry of the foreign mass distribution (when the foreign mass is distributed evenly on the beam, M=m_{c}/m₀); the amplitude of the drive force per unit mass in Eq. 2 is defined by q=W₁(L)F/m₀, and the nonlinear coefficient is defined by

α=−E/(32ρL⁴)∫₀^{2L}W₁W₁″dx∫₀^{2L}(W₁′)²dx.

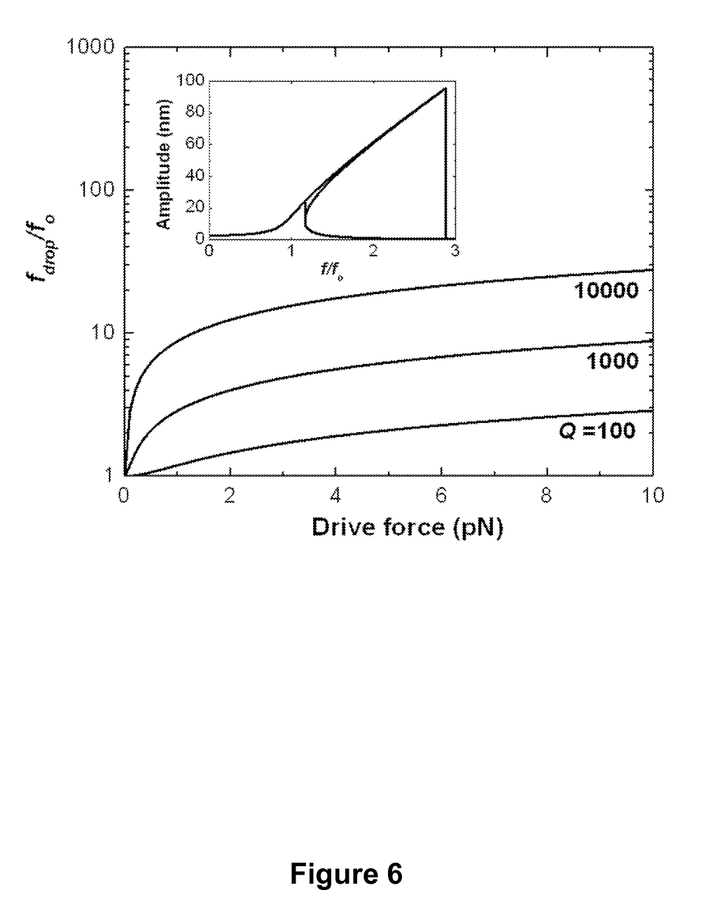

Following a harmonic balance approximation (25) with a single frequency ω, we find that the response spectrum of this Duffing oscillator forms a multi-valued region when the oscillation amplitude is over a critical value as seen in the inset of FIG. 6. Specifically, there are two branches of stable resonances that are connected by a branch of unstable resonances. As the frequency sweeps upward, the resonance amplitude in the upper branch of stable resonances increases up to the maximum possible amplitude and then drops abruptly to a lower value as the forced motion makes a transition to the lower stable branch. The drop-frequency, f_{drop}, at which this jump phenomenon occurs is approximately determined by the intersection of the Duffing response spectrum with the free-oscillation or the ‘backbone’ curve (25), and its ratio to the linearized natural frequency is given by:

$${r}_{drop} = \frac{{f}_{drop}}{{f}_{o}} = {( \frac{1 + \sqrt{1 + ( 1 + M ) Γ}}{( 1 + M )} )}^{1 / 2} , \qquad ( 3 )$$

where

$$Γ = γ \cdot {( \frac{FQ}{E} )}^{2} {( \frac{2 L}{D} )}^{6} ( \frac{1}{{D}^{4}} )$$

and γ=0.0303.
From this equation, it is clear that the drop-frequency of this nonlinear resonator depends strongly on the attached center mass and damping, besides the geometry of the beam and the applied excitation force. A similar computation can be performed for the reverse jump-up frequency during a downward frequency sweep; in that case the dynamics follows a transition from the lower stable resonance branch to the upper.

We estimate the mass responsivity (Rₘ), defined as the shift in drop-frequency with respect to the change in the added center mass:

$${R}_{m} = {lim}_{Δ {m}_{c} \to 0} \frac{Δ {f}_{drop}}{Δ {m}_{c}} = - \frac{{f}_{o}}{2 {m}_{o}} {r}_{drop} ( 1 - \frac{{r}_{drop}^{2} - 1}{2 {r}_{drop}^{2} - 1} ) {W}_{1}^{2} ( L ) . \qquad ( 4 )$$

Compared with a mass sensor based on a linear resonator, of which the responsivity is −ƒₒ/2mₒ, the nonlinear resonator utilizing the drop frequency as the measurement has a better responsivity by a factor of

r_{drop}[1−(r_{drop}²−1)/(2r_{drop}²−1)], when ignoring the term W₁²(L) and r_{drop}≧1.618

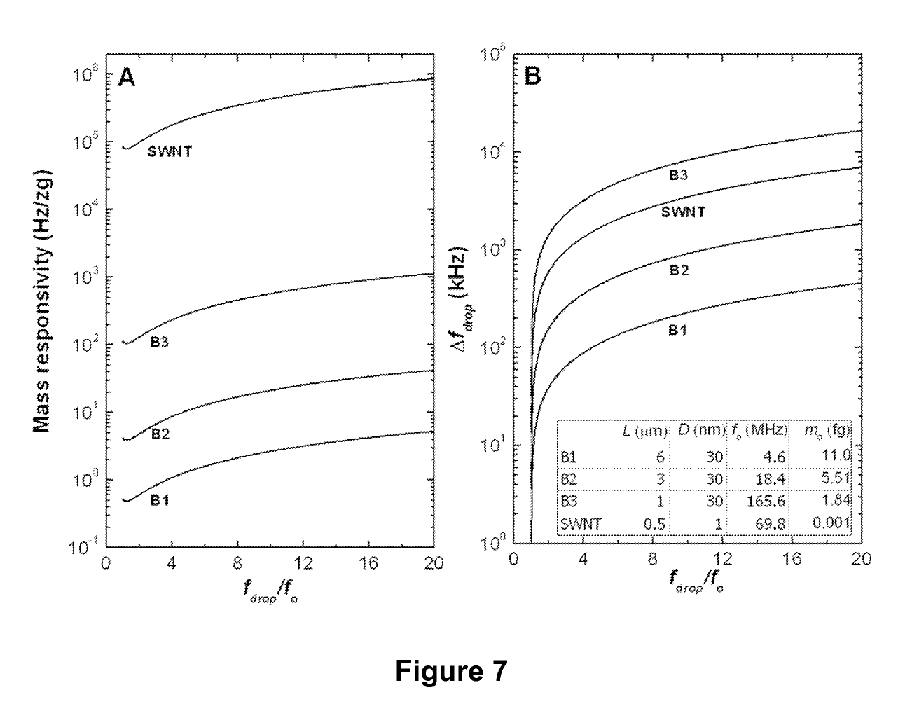

The mass responsivities of three representative doubly-clamped beams with E=100 GPa and ρ=2600 kg/m3, and a single wall CNT beam with E=1 TPa, for which parameters are listed in the inset table, are plotted in FIG. 7A as a function of the normalized frequency f_{drop}/fₒ. The value at f_{drop}fₒ=1 indicates the responsivity of a linear resonator. It is apparent that the responsivity is enhanced not only by considering a nonlinear resonator with smaller intrinsic mass and higher resonance frequency, but also by increasing the ratio of the drop frequency over the natural resonance frequency. This means that the performance of a mass sensor based on a nonlinear nanoresonator can be considerably raised by increasing its resonance bandwidth which, as we will show later, is practically tunable.

In order for a nonlinear resonator to have such an intrinsically nonlinear behavior and a highly broadband resonance response, several parameters, including the quality factor, the size of the mechanical beam, and the driving force, are to be optimized to provide a larger value of Γ according to Eq. (3). Here, it is noted that the resonance bandwidth can be extended by simply increasing the excitation force, while keeping all other parameters of the resonator fixed. FIG. 6 shows the tunability of the bandwidth up to two orders of magnitude by simply changing the excitation force applied to a nonlinear mechanical nanoresonator.

In order for a nanoresonator to operate in the linear regime, the oscillation amplitude needs to be limited below a critical value which is often less than the diameter or thickness of the mechanical beam of the nanoresonator (15). The small operating amplitude makes its detection technically challenging. For the broadband nonlinear nanoresonator, however, the oscillation amplitude at the drop-frequency is far beyond the critical amplitude, as shown in the inset of FIG. 6. Furthermore, the measurement bandwidth (Δf) can also be reduced because the slope of response at the point of the jump is theoretically infinite.

In addition, the drop-frequency of the nonlinear nanoresonator is highly sensitive to the magnitude of damping associated with the resonance system under various ambient conditions, according to Eq. (3). The damping responsivity of the drop-frequency is estimated according to the change in the damping coefficient, ξ, where ξ=1/(2Q):

$${R}_{ξ} = {lim}_{Δ ξ \to 0} \frac{Δ {f}_{drop}}{Δ ξ} = \frac{{f}_{o}}{ξ} {r}_{drop} ( \frac{{r}_{drop}^{2} - 1}{2 {r}_{drop}^{2} - 1} ) . \qquad ( 5 )$$

The shift in drop frequency for a 1% change in the damping coefficient is plotted in FIG. 7B, and again shows the much enhanced sensitivity offered by the intrinsically nonlinear nanoresonator compared to the linear one.

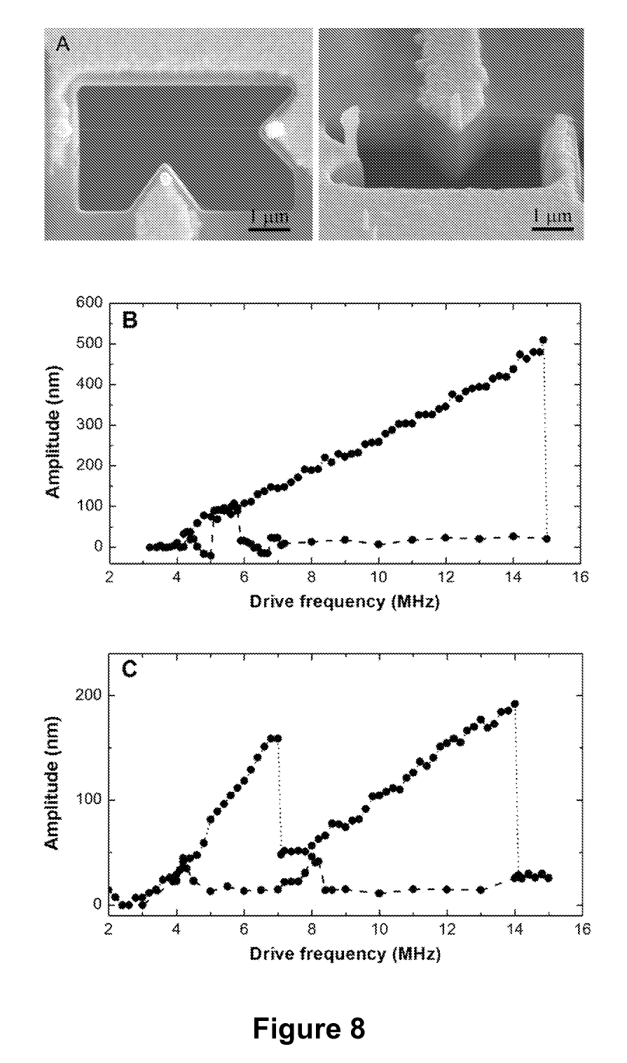

We fabricate a nonlinear nanoresonator using a doubly-clamped carbon nanotube (CNT), of which a scanning electron microscope (SEM) image is displayed in FIG. 8A. The device is fabricated through micromachining and nanomanipulation. A silicon (100) wafer is coated with a 500 nm thick silicon nitride layer followed by 1.5 μm thick silicon dioxide. A thin Cr/Au layer is then sputter-coated onto the silicon wafer and subsequently patterned through photolithography to form a three-electrode layout. This silicon wafer is back-etched in KOH to make a thin membrane of silicon dioxide under the electrodes. The window is then milled with a focused ion beam to create three suspended electrodes. Three vertical platinum posts are fabricated onto these three electrodes through the electron beam-induced deposition. A high quality multiwall CNT produced with arc-discharge is then selected and manipulated inside an electron microscope and suspended between two of the platinum posts with both ends fixed with electron beam-induced deposition of a small amount of platinum. The remaining platinum post is used as the driving electrode for applying the localized oscillating electric field to drive the oscillation of the CNT. The overall design of the device maximizes the localization of the excitation force applied to the CNT beam. According to the previous discussion, the localization of the applied force is necessary for creating the strong geometric nonlinearity in the resonance system.

To acquire the response spectrum of the nanoresonator, the frequency of the applied AC driving voltage (V_{ac}) is swept upward and then downward, while the oscillation amplitude at the middle of the CNT is measured from the acquired images in an SEM. To evaluate the effect of an added mass on the dynamic behavior of the nanoresonator, a small amount of platinum is deposited at the middle of the CNT with the electron beam induced deposition, and its mass is estimated from the measured dimension.

FIG. 8B shows the acquired response spectrum for a nonlinear nanoresonator incorporating a CNT of 2L=˜6.2 μm and D=˜33 nm driven with an AC signal of 10 V in amplitude. The initiation of the oscillation begins at around 4 MHz, near the natural resonance frequency of this doubly-clamped CNT. The amplitude of the resonance oscillation increases continuously during the upward frequency sweep up to 14.95 MHz, at which point the amplitude suddenly drops to zero (referred herein as the “jump” frequency or the “drop” frequency). This response resembles closely what had been modeled previously for an intrinsically nonlinear nanoresonator and corresponds to a resonance bandwidth of over 10 MHz. During the ensuing downward frequency sweep (dashed line), the resonator stays mostly in a non-resonance state until the neighborhood of the natural resonance frequencies of the CNT, where transitions back to resonant oscillations occur. By fitting the obtained drop-jump and up-jump frequencies with the model prediction, the drive force is estimated to be ˜7 pN and the Q factor of the system ˜260, which are in agreement with the estimate from an electrostatic analysis based on the experimental setup and the reported Q factor values for typical CNT-based resonators (27), respectively.

The occurrence of multiple up-jump transitions during the downward frequency sweep appears to be due to the existence of multiple natural resonance frequencies in a multiwall CNT and thus multiple modes of resonance. In theory (28), there are the same numbers of fundamental frequencies and resonance modes as the numbers of cylinders in a multiwall CNT. In a recent computational study (29) it was shown that in the strongly nonlinear regime there can be coupling between multiple radial and axial modes of a double-walled CNT, with van der Waals forces provoking dynamical transitions between the modes of the inner and outer walls. Such strongly nonlinear modal interactions can be studied using asymptotic techniques in the context of coupled nonlinear oscillators (30).

The existence of multiple natural modes in this multiwall CNT-based nonlinear resonator can also be revealed in an upward frequency sweep when the drive force is reduced. FIG. 8C shows the response spectrum acquired from the same resonator when the applied AC amplitude is reduced to 5 V. Two distinct resonance modes are excited in this case. The first mode appears around 4 MHz and its drop-jump occurred at 7.05 MHz. The second mode then initiated right after the drop-jump of the first mode, and jumped down at 14.15 MHz. As shown previously, when the drive force is increased, it appears that the first mode resonance becomes dominant and suppresses the initiation of the second mode in the upward frequency sweep; while in the downward frequency sweep, since there is no dominant mode, those modes are excited in the neighborhoods of their linearized resonance frequencies. Similar observations have been reported in coupled nonlinear resonators (17) but not, until now, for a multiwall CNT intentionally operated in a highly nonlinear regime.

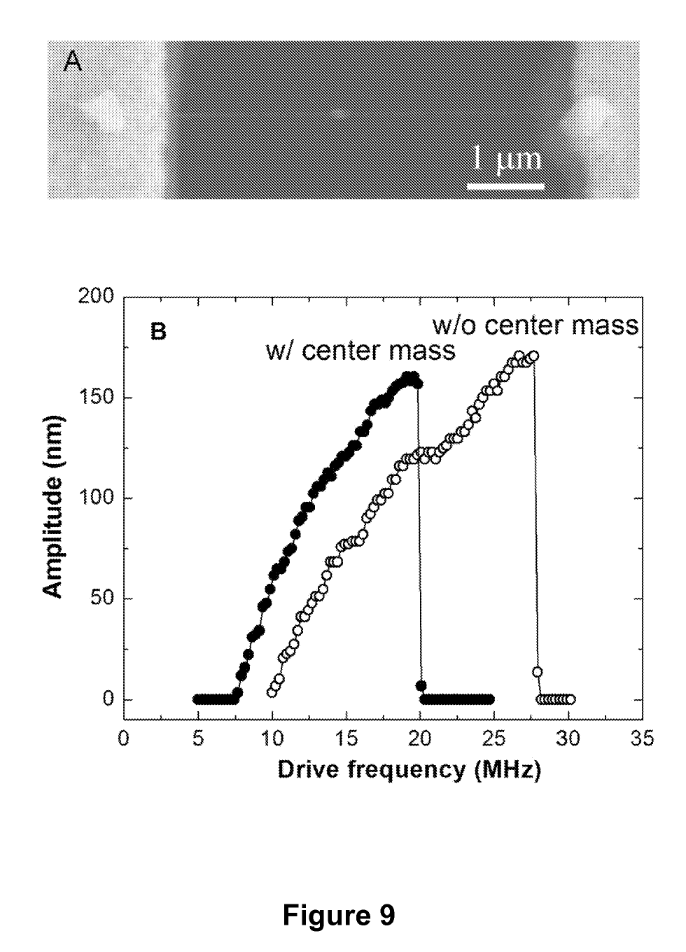

The mass sensing capability of the nonlinear nanoresonator is evaluated by adding a small platinum deposit at the middle of a suspended CNT, as shown in FIG. 9. In this case the CNT is ˜6.0 μm long and ˜26 nm in diameter. The added mass causes both a 2.0 MHz shift of the linearized natural frequency, approximately defined as the frequency where the resonance oscillation initiated, and a more significant 7.4 MHz shift of the drop frequency. The added mass is estimated to be ˜7 fg based on the dimension of the deposit measured from the acquired SEM images. The corresponding mass responsivity calculated from the shift in the drop frequency (R_{m,nonlinear}=1.06 Hz/zg) is thus immediately 3.7 times that calculated from the linearized natural frequency (R_{m,linear}=0.29 Hz/zg). These mass responsivity values compare favorably with the model prediction in which R_{m,nonlinear}=2.18 Hz/zg and R_{m,linear}=0.60 Hz/zg.

It is noted that there is ample room to further increase the drop frequency and the quality factor of the nanoresonator with optimized design, which would further increase the mass sensitivity. It is further noted that with the intrinsically nonlinear nanoresonator, mass detection in the zepto-gram level can be potentially realized at room temperature, as the required measurement bandwidth can be significantly reduced due to the sharp transition at the drop frequency.

The ability of a nonlinear mechanical resonator to greatly expand the bandwidth of the resonance response, to be tunable over a broad frequency range, and to provide the inherent instabilities that produce elevated sensitivity to external perturbations offers new conceptual strategies for the development of high sensitivity sensors. Such development is further facilitated by the inherent ease of realizing intrinsic geometric nonlinearity in a nanoscale resonator, and can thus be readily integrated into the ongoing development of nanoscale electromechanical systems to extend their operation.

### TABLE OF REFERENCES

1. H. J. Mamin, D. Rugar, Appl. Phys. Lett. 79, 3358 (2001).
2. R. G. Knobel, A. N. Cleland, Nature 424, 291 (2003).
3. B. Ilic et al., J. Appl. Phys. 95, 3694 (2004).
4. B. Ilic, Y. Yang, H. G. Craighead, Appl. Phys. Lett. 85, 2604 (2004).
5. K. L. Ekinci, X. M. H. Huang, M. L. Roukes, Appl. Phys. Lett. 84, 4469 (2004).
6. B. Ilic et al., Nano Lett. 5, 925 (2005).
7. Y. T. Yang, C. Callegari, X. L. Feng, K. L. Ekinci, M. L. Roukes, Nano Lett. 6, 583 (2006).
8. M. Li, H. X. Tang, M. L. Roukes, Nature Nanotech. 2, 114 (2007).
9. K. Jensen, K. Kim, A. Zettl, Nature Nanotech. 3, 533 (2008).
10. H.-Y. Chiu, P. Hung, H. W. C. Postma, M. Bockrath, Nano Lett. 8, 4342 (2008).
11. A. K. Naik, M. S. Hanay, W. K. Hiebert, X. L. Feng, M. L. Roukes, Nature Nanotech. 4, 445 (2009).
12. M. D. LaHaye, O. Buu, B. Camarota, K. C. Schwab, Science 304, 74 (2004).
13. K. C. Schwab, M. L. Roukes, Phys. Today 58, 36 (2005).
14. D. Rugar, R. Budakian, H. J. Mamin, B. W. Chui, Nature 430, 329 (2004).
15. H. W. Ch. Postma, I. Kozinsky, A. Husain, M. L. Roukes, Appl. Phys. Lett. 86, 223105 (2005).
16. I. Kozinsky, H. W. Ch. Postma, I. Bargatin, M. L. Roukes, Appl. Phys. Lett. 88, 253101 (2006).
17. R. B. Karabalin, M. C. Cross, M. L. Roukes, Phys. Rev. B 79, 165309 (2009).
18. J. S. Aldridge, A. N. Cleland, Phys. Rev. Lett. 94, 156403 (2005).
19. E. Buks, B. Yurke, Phys. Rev. E 74, 046619 (2006).
20. I. Kozinsky, H. W. Ch. Postma, O. Kogan, A. Husain, M. L. Roukes, Phys. Rev. Lett. 99, 207201 (2007).
21. Y. M. Fu, J. W. Hong, X. Q. Wang, J. Sound. Vib 296, 746 (2006).
22. F. N. Mayoof, M. A. Hawwa, Chaos, Solitons Fractals 42, 1860 (2009).
23. S. C. Jun, J. M. Kim, H. J. Kim, Electron. Lett. 43, (2007).
24. A. F. Vakakis et al., Passive nonlinear targeted energy transfer in mechanical and structural systems. (Springer Verlag, 2008).
25. A. H. Nayfeh, D. T. Mook, Nonlinear oscillations. (Wiley, 1995).
26. K. L. Ekinci, Y. T. Yang, M. L. Roukes, J. Appl. Phys. 95, 2682 (2004).
27. F. Léonard, Physics of carbon nanotube devices (William Andrew, 2008).
28. J. Yoon, C. Q. Ru, A. Mioduchowski, Compos. Sci. Technol. 63, 1533 (2003).
29. Y. Yan, L. X. Zhang, W. Q. Wang, J. Appl. Phys. 103, 113523 (2008).
30. A. F. Vakakis, Nonlinear Dyn. 3, 123 (1992).

Derivation of the Drop-Frequency:

Consider a doubly-clamped beam with a foreign mass attached at the middle and excited transversely by a periodic center-concentrating force, the nonlinear vibration of the beam is described by

[ρA+m_{c}δ(x−L)]wₜₜ+(mω₀/Q)wₜ+EIwₓₓₓₓ−(EA/4L)wₓₓ∫₀^{2L}wₓ²dx=F cos ωtδ(x−L) (S1)

The parameters are same as those defined in the manuscript. The displacement of the beam can be approximated as

$$w ( x , t ) = {\sum }_{i = 1}^{N} {W}_{i} ( x ) {φ}_{i} ( t )$$

by discretizing the continuous system using a series of linear eigenfunctions. Here, the i-th linearized mode shape of the beam is given by

Wᵢ(x)=kᵢ[sin λᵢx−sin λᵢx]+[cos λᵢx−cos λᵢx], (S2)

where k=(cos 2λᵢL−cos 2λᵢL)/sin 2λᵢL−sin h2λᵢL) and the eigenvalues λᵢ are the positive roots of the equation, cos λᵢ cos λᵢ=1. The displacement of the first mode at the middle of the beam is W₁(L)φ₁(t) with W₁(L)=1.59 for a doubly-clamped beam.

The leading model amplitude, φ₁(t), is approximately governed by a Duffing equation obtained by discretizing Eq. S2 through a standard one-mode Galerkin approach (1):

$$( 1 + M ) {\ddot{φ}}_{1} + \frac{{ω}_{o}}{Q} {\dot{φ}}_{1} + {ω}_{o}^{2} {φ}_{1} + α {φ}_{1}^{3} = q cos ( ω t ) . \qquad ( S3 )$$

When there is damping, the steady-state vibration will have a phase angle, φ, and we assume that φ₁=c₁ cos(ωt−φ). Then, by applying the Ritz second method (2), the relation among the drive frequency, the amplitude c₁ and the phase φ are given by:

$$\begin{matrix}{( \frac{3}{4} \frac{α}{{ω}_{o}^{2}} )}^{2} {c}_{1}^{3} = ( ( 1 + M ) \frac{{ω}^{2}}{{ω}_{o}^{2}} - 1 ) {c}_{1} - \frac{q}{{ω}_{o}^{2}} \sqrt{1 - \frac{{( {ωω}_{o} {c}_{1} / Q )}^{2}}{{q}^{2}}} , & ( S4 ) \\ ϕ = {tan}^{- 1} ( \frac{{ωω}_{o} / Q}{- ( 1 + M ) {ω}^{2} + {ω}_{o}^{2} + \frac{3}{4} α {c}_{1}^{2}} ) . & ( S5 )\end{matrix}$$

The ‘backbone’ curve, corresponding to the response of the nonlinear free vibration, is obtained by setting q equal to zero in Eq. S3:

$${( \frac{3}{4} \frac{α}{{ω}_{o}^{2}} )}^{2} {c}_{1}^{2} = ( ( 1 + M ) \frac{{ω}^{2}}{{ω}_{o}^{2}} - 1 ) . \qquad ( S6 )$$

Substituting the equation of locus where the spectrum intersects with the backbone curve,

$${c}_{1} = \frac{q}{{ωω}_{0} / Q} ,$$

to Eq. S4 yields

$$( 1 + M ) {r}_{drop}^{4} - {r}_{drop}^{2} - \frac{3}{4} \frac{α {q}^{2} {Q}^{2}}{{ω}_{0}^{6}} = 0. \qquad ( S7 )$$

The positive roots of Eq. S7 is the drop-frequency, which is given by:

$$\begin{matrix}{r}_{drop} = \frac{{f}_{drop}}{{f}_{o}} = {( \frac{1 + \sqrt{1 + ( 1 + M ) Γ}}{( 1 + M )} )}^{1 / 2} where & ( S8 ) \\ Γ = \frac{3 α {q}^{2} {Q}^{2}}{{ω}_{0}^{6}} = γ \cdot {( \frac{FQ}{E} )}^{2} {( \frac{2 L}{D} )}^{6} ( \frac{1}{{D}^{4}} ) . & ( S9 )\end{matrix}$$

For a CNT used in the experiment, substituting the parameters, 2L=6.2 μm, D=33 nm, F=7 pN, Q=260, M=0, and E=73 GPa yields r_{drop} of 3.7 corresponding to the experimental result.

Estimation of the Applied Drive Force:

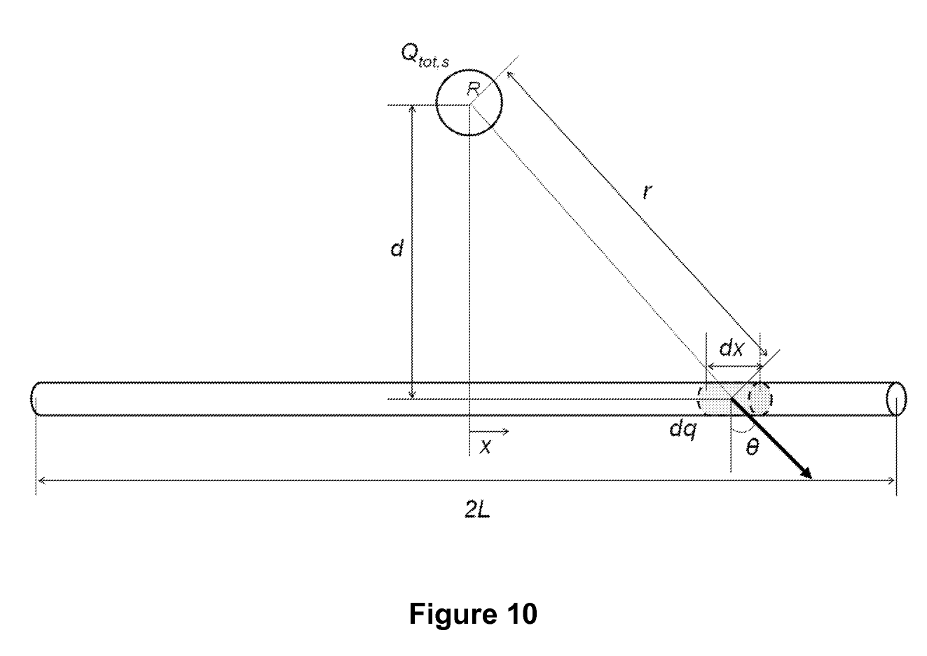

The geometric layout of the device is schematically depicted in FIG. 10. The platinum post acts as a counter electrode for applying the electric field is modeled as a sphere and the carbon nanotube beam as a cylinder. When the radius of the sphere (R) is much smaller than the distance (d) between the sphere and the cylinder (R<<((d), the total induced charge on the sphere is given by Qₛ=(4πεₒ)RV, where εₒ is the electric permittivity and V is the potential difference between the sphere and the cylinder. The charge distributed on a specific location on the cylinder is inversely proportional to the distance r, so the charge at position x is described by q(x)=k/r, where k is a proportional constant. Practically assuming that the total amount of induced charge on the cylinder is the same as the charge on the sphere, k can be obtained from the following equation:

$${Q}_{s} = {\int }_{- L}^{+ L} q ( x ) d x = {\int }_{- L}^{+ L} \frac{k}{\sqrt{{x}^{2} + {d}^{2}}} d x = k ln \frac{L + \sqrt{{L}^{2} + {x}^{2}}}{- L + \sqrt{{L}^{2} + {x}^{2}}} \qquad ( S10 )$$

The electrostatic force per unit length at x is then:

$${F}^{*} ( x ) = \frac{1}{4 π {ɛ}_{o}} \frac{{Q}_{s} q ( x )}{{r}^{2}} = \frac{{Q}_{s} k}{4 {πɛ}_{o}} \frac{1}{{( {x}^{2} + {L}^{2} )}^{3 / 2}} , \qquad ( S11 )$$

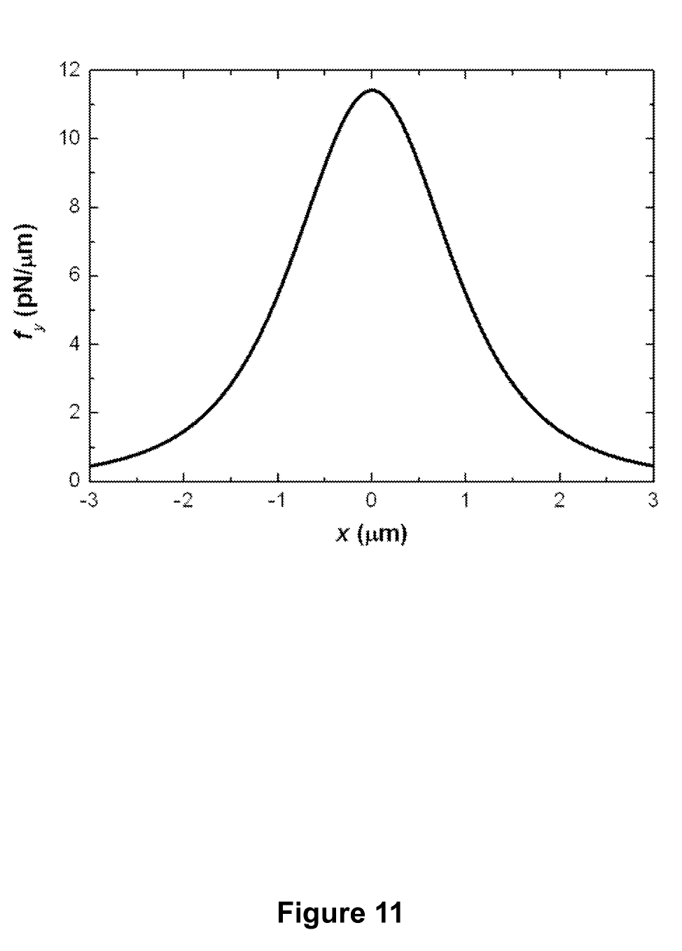

and the force components in the transverse and longitudinal directions are F_{y}*(x)=ƒ(x) cos θ and Fₓ*(x)=ƒ(x) sin θ, respectively. The distribution of the transverse force per unit length applied on the carbon nanotube is thus calculated based on the experimental parameters (R=100 nm, d=1.5 μm, 2L=6 μm, and V=10 V) and is shown in FIG. 11. The force at the middle of the beam is over an order of magnitude higher than at the ends, approximating a center-concentrated drive force necessary for realizing the geometric nonlinear resonance. The total force is obtained by integrating Eq. S11 over the whole beam length and is calculated to be ˜26 pN, which is larger than the force, ˜7 pN, estimated in the manuscript. It is expected, however, that the above electrostatic calculation overestimates the induced charge on the carbon nanotube and thus the interaction force, as the distribution of the induced charge on the surrounding objects, such as the conductive leads, is not considered.

Young's Modulus and Natural Frequency of Carbon Nanotube:

For a doubly-clamped carbon nanotube of the reported size, the critical amplitude defining the linear regime for the resonance is too small to be observed with SEM and thus to construct a resonance response spectrum. The frequency at which the oscillation initiates in the nonlinear response spectrum is reasonably considered as the natural frequency according to the understandings derived from our modeling. With the use of such frequencies as the natural resonance frequencies and according to the measured dimensions of the carbon nanotube, the Young's moduli of the carbon nanotubes used in the example corresponding to the results shown in FIGS. 8 and 9 are calculated to be 73 GPa for the carbon nanotube having a diameter of ˜33 nm and 630 GPa for the carbon nanotube having a diameter of ˜26 nm, respectively. The values are within the range of the reported Young's modulus of CNTs (3). A small pretension within the suspended carbon nanotube may exist, which would affect the above estimates, but would not affect the nonlinear resonance behavior of the resonator, such as the drop frequency, the mass responsivity or the mass sensitivity described in the example.

The Added Mass Produced with the Electron Beam-Induced Pt Deposition:

The Pt deposit in FIG. 9a is measured to approximate an ellipsoid from the acquired SEM images and has a size of 200 nm×150 nm×50 nm and a volume of 4.4×10⁵ nm³. The volume of CNT inside the ellipsoid is subtracted to get the volume of the actual Pt deposit, 3.4×10⁵ nm³. Taking the mass density of the bulk platinum, 21 g/cm³, the added mass is estimated to be ˜7 fg.
1. A. H. Nayfeh, D. T. Mook, Nonlinear oscillations. (Wiley, 1995).
2. S. Timoshenko, D. H. Young, J. W. Weaver, Vibration problems in engineering. (Wiley, ed. 4th, 1974).
3. A. Kis, A. Zettl, Phil. Trans. R. Soc. A 366, 1591 (2008).

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure.

Every formulation or combination of components described or exemplified herein can be used to practice the invention, unless otherwise stated. Although nucleotide sequences are specifically exemplified as DNA sequences, those sequences as known in the art are also optionally RNA sequences (e.g., with the T base replaced by U, for example).

Whenever a range is given in the specification, for example, a physical parameter range (modulus, dimension), strain, stress, a temperature range, a time range, or a composition or concentration range, all intermediate ranges and subranges, as well as all individual values included in the ranges given (e.g., within a range and at the ends of a range) are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A nanoresonator component comprising:
an elongated nanostructure having a central portion, a first end, and a second end, wherein said central portion is positioned between said first end and second end, and each of said first and second ends are fixed in position; and
an electrode having a protrusion ending in a tip, wherein said tip is positioned adjacent to said elongated nanostructure central portion, and the longitudinal axis of said protrusion is substantially transverse to the longitudinal axis of said elongated nanostructure;
wherein upon resonance said elongated nanostructure generates non-linear resonance having a broadband resonance range that spans a frequency range of at least one times the elongated nanostructure natural resonance frequency.

2. The nanoresonator component of claim 1 wherein said elongated nanostructure is a nanowire or a nanotube.

3. The nanoresonator component of claim 1, wherein said tip comprises a tapered geometry.

4. The nanoresonator component of claim 1, wherein said elongated nanostructure has a longitudinal length and said tip has a characteristic width, wherein said characteristic width is less than or equal to 10% of said elongated nanostructure longitudinal length.

5. The nanoresonator component of claim 1, wherein said electrode has a substantially rectangular geometry, having a width in a direction in longitudinal alignment with said elongated nanostructure that is less than or equal to 10% the length of said elongated nanostructure.

6. The nanoresonator component of claim 1, wherein said tip is positioned a separation distance from said elongated nanostructure, wherein said separation distance is less than or equal to 20 μm.

7. The nanoresonator component of claim 1, wherein said elongated nanostructure has an outer diameter that is less than or equal to 300 nm and a length that is less than or equal to 100 μm.

8. The nanoresonator component of claim 1, further comprising:
a first end electrode connected to said elongated nanostructure first end; and
a second end electrode connected to said elongated nanostructure second end.

9. The nanoresonator component of claim 1, wherein said broadband resonance ranges from the natural resonance frequency of said elongated nanostructure to 1 GHz.

10. The nanoresonator component of claim 1, wherein the central portion corresponds to a point that is equidistant from said first end and said second end.

11. The nanoresonator component of claim 1, wherein said electrode generates an electric field induced force on said elongated nanostructure central region, wherein said electric field induced force has a direction that is substantially perpendicular to the longitudinal axis of said elongated nanostructure.

12. The nanoresonator component of claim 1, wherein said elongated nanostructure is substantially tension-free at rest or has a tension smaller than that required to produce a corresponding strain of 0.002 in said elongated nanostructure at rest.

13. A method of detecting a physical parameter with a nonlinear broadband nanoresonator, said method comprising:
providing the nanoresonator component of claim 1;
supplying an oscillating electric potential to said electrode tip to generate an oscillating driving point force positioned at said elongated nanostructure central region, wherein said driving point force generates a nonlinear resonance from the elongated nanostructure; and
measuring a resonance parameter, thereby detecting said physical parameter.

14. The method of claim 13, wherein the supplied oscillating electric potential generates a periodic driving point force within said elongated nanostructure central region.

15. The method of claim 13, wherein said physical parameter is
mass of an analyte,
energy transfer between the elongated nanostructure and a second nanoscale device operably connected to the nanoresonator; or
a property of an environment surrounding said nanoresonator selected from the group consisting of pressure, viscosity, magnetic field, and electric field.

16. The method of claim 13, wherein the resonance parameter is selected from the group consisting of:
drop frequency or shift in drop frequency,
resonance bandwidth,
phase of the resonance;
amplitude; and
slope of the resonant curve at one or more selected frequencies.

17. The method of claim 13, further comprising functionalizing at least a portion of said elongated nanostructure to facilitate specific binding between an analyte and said elongated nanostructure; wherein said measured resonance parameter indicates the presence or absence of said analyte.

18. The method of claim 13, wherein the detection occurs under an environmental condition selected from the group consisting of:
vacuum pressure;
atmospheric or ambient pressure;
at room temperature;
below room temperature; and
above room temperature.

19. The method of claim 13, wherein the physical parameter is mass, and said method provides a sensitivity that is at least 1 femtogram or 1 attogram at room temperature.

20. The method of claim 13, wherein the nanoresonator is driven at a sweeping resonant frequency, wherein said resonant frequency sweep ranges from a minimum that is less than or equal to 5 MHz to a maximum that is greater than or equal to 14 MHz.

21. A method for measuring mass comprising the steps of:
providing a nonlinear nanoelectromechanical resonator including an oscillating element and an electronic circuit to drive the oscillating element, the nanomechanical resonator exhibiting an initial jump frequency under vacuum or ambient conditions;
adsorbing mass onto the oscillating element;
determining the jump frequency of the nanomechanical resonator in the presence of the adsorbed mass, wherein the change from the initial value of the jump frequency indicates the magnitude of the mass added to the oscillating element.

22. The method of claim 21, wherein the nonlinear nanoelectromechanical resonator comprises
an elongated nanostructure having a central portion, a first end, and a second end, wherein said central portion is positioned between said first end and second end, and each of said first and second ends are fixed in position; and
an electrode having a protrusion ending in a tip, wherein said tip is positioned adjacent to said elongated nanostructure central portion, and the longitudinal axis of said protrusion is substantially transverse to the longitudinal axis of said elongated nanostructure;
wherein upon resonance said elongated nanostructure generates non-linear resonance having a broadband resonance range that spans a frequency range of at least one times the elongated nanostructure natural resonance frequency.
